(19) United States
(12) Patent Application Publication
(10) Pub. No.: US 2026/0249840 A1
(43) Pub. Date: Aug. 27, 2026

(54) PARKING ASSISTANCE DEVICE

(71) Applicant: TOYOTA JIDOSHA KABUSHIKI KAISHA, Aichi (JP)

(72) Inventor: Eiji SAKAGUCHI, Miyoshi-shi (JP)

(21) Appl. No.: 19/543,861

(22) Filed: Feb. 19, 2026

(30) Foreign Application Priority Data
Feb. 27, 2025 (JP) 2025-030566

(51) Int. Cl. B60W 30/06

(52) U.S. Cl. CPC B60W 30/06; B60W 2520/10

(57) ABSTRACT

A parking assistance device comprising an electronic control unit that sets a target trajectory from a parking start position to a target parking position based on information acquired by an object information acquisition device, and controls a host vehicle to automatically move along the target trajectory. The electronic control unit is configured, when the host vehicle is traveling in a parking area, to store information of a travel region in which at least one of the host vehicle and another vehicle has traveled based on the information acquired by the object information acquisition device, and, even when the electronic control unit determines that there is an obstacle that obstructs the movement of the host vehicle along the target trajectory, to automatically move the host vehicle along the target trajectory when the electronic control unit further determines that the obstacle is within the travel region.

### CROSS-REFERENCE TO RELATED APPLICATION

This application claims priority to Japanese Patent Application No. JP 2025-030566 filed on Feb. 27, 2025, the content of which is hereby incorporated by reference in its entirety into this application.

### BACKGROUND

### 1. Technical Field

The present disclosure relates to a parking assistance device for a vehicle such as an automobile, and more particularly to a parking assistance device configured to move the vehicle by automatic driving along a target trajectory.

### 2. Description of the Related Art

As one type of parking assistance device for a vehicle such as an automobile, there is known a parking assistance device comprising: a target trajectory setting means for setting a target trajectory from a parking start position to a target parking position based on object information around the vehicle acquired by an object information acquisition device; and an automatic driving means for moving the vehicle along the target trajectory.

Further, in the control of parking assistance, when it is determined that there is an obstacle that obstructs the movement of the vehicle along the target trajectory from the parking start position to the target parking position, it is known to terminate the control of parking assistance, or alternatively to reset the target trajectory so that the obstacle does not interfere.

For example, Japanese Patent Application Laid-open Publication No. 2019-182154 discloses a parking assistance device wherein, based on an area recognized as drivable for a vehicle according to external information, a candidate route is generated from a current position of the vehicle to a target parking position; a turning-back position is provided at a predetermined location on the candidate route; a preliminary route is generated from the turning-back position to the target parking position; and, when generation of the preliminary route is possible, the candidate route is adopted as the target route.

In conventional parking assistance devices, a target trajectory is set based on information acquired by an object information acquisition device, and a determination is made as to whether or not there is an obstacle that obstructs movement of a vehicle along a target trajectory. In this determination, an object that does not actually constitute an obstacle to the movement of the vehicle—for example, a road surface marking—may be erroneously determined to be an obstacle. As a result, control of parking assistance may be unnecessarily terminated and the parking assistance may not be executed, or the target trajectory may be reset to a non-optimal trajectory that avoids a region in which the vehicle can in fact travel.

### SUMMARY

The present disclosure has been made in view of the above, and it is an object of the disclosure to provide an improved parking assistance device capable of preventing such adverse effects as above from occurring, without requiring an obstacle detection device other than the object information acquisition device, even when an object that does not actually obstruct movement of a vehicle is determined to be an obstacle.

According to the present disclosure, there is provided a parking assistance device comprising: an object information acquisition device configured to acquire information of objects around a host vehicle; and an electronic control unit that is configured to set a target trajectory from a parking start position to a target parking position based on information acquired by the object information acquisition device, and to execute automatic parking control for controlling the host vehicle to automatically move along the target trajectory from the parking start position to the target parking position.

The electronic control unit is configured, when the host vehicle is traveling within a parking area, to store information of a travel region in which at least one of the host vehicle and another vehicle has traveled is stored based on the information acquired by the object information acquisition device, and, even if the electronic control unit determines that there is an obstacle that obstructs the movement of the host vehicle along the target trajectory from the parking start position to the target parking position, to automatically move the host vehicle along the target trajectory when the electronic control unit further determines that the obstacle is within the travel region.

According to the above configuration, when the host vehicle is traveling within a parking area, information of a travel region in which at least one of the host vehicle and another vehicle has traveled is stored based on the information acquired by the object information acquisition device. Further, even if it is determined that there is an obstacle that obstructs the movement of the host vehicle along the target trajectory from the parking start position to the target parking position, when it is determined that the obstacle is within the travel region, the host vehicle is automatically moved along the target trajectory.

Therefore, it is possible to prevent the parking assistance control from being unnecessarily terminated and to prevent the target trajectory from being reset to a non-optimal trajectory that avoids a region in which the vehicle can in fact travel.

Moreover, no device for detecting obstacles other than the object information acquisition device is required. Therefore, it is possible to avoid complicating the structure of the parking assistance device and to avoid increasing the cost thereof.

In one aspect of the disclosure, the electronic control unit is configured to determine whether or not the obstacle is in the travel region based on the information of the travel region stored after a time point that is a predetermined time before the time when the host vehicle has stopped.

According to the above aspect, it is possible to prevent determination of whether or not the obstacle is in the travel region from being made based on old information of the travel region in which at least one of the host vehicle and another vehicle has traveled. Furthermore, the storage capacity required for a storage device for storing the travel region can be reduced.

In another aspect of the disclosure, the electronic control unit is configured to determine that the host vehicle is traveling in a parking area when the electronic control unit determines, based on the information acquired by the object information acquisition device, that at least one parking space is within a predetermined distance from the host vehicle.

According to the above aspect, it is possible to prevent unnecessary acquisition and storage of information of the travel region when the host vehicle is traveling in an area where parking is not possible.

In another aspect of the disclosure, the electronic control unit is configured to determine that the host vehicle is traveling in a parking area when the electronic control unit determines, based on the information acquired by the object information acquisition device, that at least one parking space is within the predetermined distance from the host vehicle and that a vehicle speed of the host vehicle is equal to or lower than a reference value.

According to the above aspect, it is possible to prevent unnecessary acquisition and storage of information of the travel region even when the host vehicle is merely passing through the parking area without parking.

In another aspect of the disclosure, the electronic control unit is configured, when the electronic control unit determines that an obstacle is not within the travel region, to reset the target trajectory so that the host vehicle does not collide with the obstacle.

According to the above aspect, when it is determined that the obstacle is not within the travel region, the target trajectory is reset so that the host vehicle does not collide with the obstacle. Accordingly, it is possible to prevent the parking assistance control from being terminated, and the host vehicle can be moved to the target parking position and parked while avoiding collision with the obstacle.

The electronic control unit may be configured to notify an occupant or occupants that the target trajectory cannot be reset when it is not possible to reset the target trajectory so as to avoid collision with the obstacle.

Other objects, features, and advantages of the present disclosure will become readily understood from the following description of an embodiment of the disclosure with reference to the accompanying drawings.

### BRIEF DESCRIPTION OF THE DRAWINGS

FIG. 1 is a schematic configuration diagram showing a parking control device according to an embodiment.

FIG. 2 is a flowchart corresponding to a control program for acquiring information of a travel region in the embodiment.

FIG. 3 is a flowchart corresponding to an automatic parking control program in the embodiment.

FIG. 4 is a diagram showing a case where a road surface marking is determined to be an obstacle and the road surface marking is within the travel region.

FIG. 5 is a diagram showing a case where a road surface marking is determined to be an obstacle and the road surface marking is not within the travel region.

FIG. 6 is a diagram showing a case where a stopped vehicle is determined to be an obstacle obstructing the movement of the host vehicle.

### DETAILED DESCRIPTION

Hereinafter, with reference to the accompanying drawings, a parking assistance device according to an embodiment of the present disclosure will be described in detail.

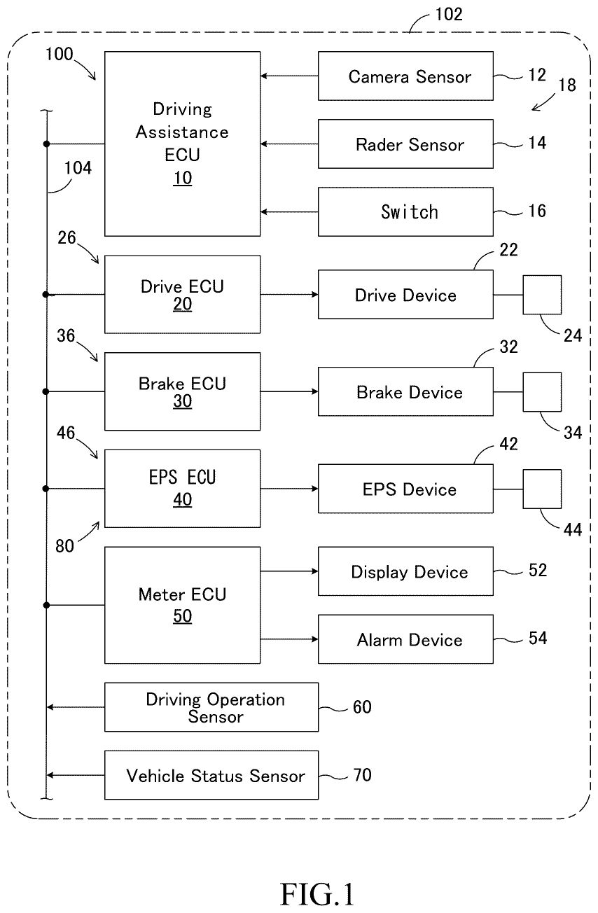

As shown in FIG. 1, a parking assistance device 100 according to the embodiment of the present disclosure is applied to a vehicle 102 and comprises a driving assistance ECU 10. The vehicle 102 is a vehicle capable of autonomous driving and is provided with a drive ECU 20, a brake ECU 30, an electric power steering ECU 40, and a meter ECU 50. The term ECU refers to an electronic control unit including a microcomputer as its main component. The vehicle 102 may also be referred to as the host vehicle 102 as needed, and the electric power steering is hereinafter referred to as EPS.

The microcomputer of each ECU comprises a CPU, ROM, RAM, rewritable non-volatile memory (N/M), and an interface (I/F). The CPU realizes various functions by executing instructions (programs, routines) stored in the ROM. Furthermore, these ECUs are connected to each other via a CAN (Controller Area Network) 104, and are able to exchange (communicate) data. Therefore, detection values of sensors (including switches) connected to a specific ECU are also transmitted to other ECUs.

The driving assistance ECU 10 is a central control unit that performs control of driving assistance such as parking assistance control and inter-vehicle distance control. In the embodiment, as described later, the driving assistance ECU 10 executes parking assistance control in cooperation with other ECUs.

The driving assistance ECU 10 is connected with a camera sensor 12, a radar sensor 14, and a switch 16. The camera sensor 12 and the radar sensor 14 each comprise a plurality of camera devices and a plurality of radar devices, respectively. The camera sensor 12 and the radar sensor 14 function as an object information acquisition device 18 that acquires object information around the vehicle 102.

Each camera device of the camera sensor 12 is provided with a camera unit (not shown in the figure) configured to capture the surroundings of the vehicle 102, and a recognition unit configured to recognize road markings, other vehicles and other objects by analyzing image data captured by the camera unit. The recognition unit supplies information regarding the recognized objects to the driving assistance ECU 10 at predetermined time intervals.

Each radar device of the radar sensor 14 uses millimeter-wave radio waves to detect a distance between the host vehicle 102 and an object, a relative speed between the host vehicle and the object, and a relative position (direction) of the object with respect to the host vehicle, and supplies information representing these at predetermined time intervals to the driving assistance ECU 10. Instead of, or in addition to, the radar sensor 14, a LiDAR (Light Detection And Ranging) may be employed.

The switch 16 is provided at a position operable by a driver, such as on a steering wheel (not shown in FIG. 1), and is operable by the driver. The switch 16 comprises an automatic parking control switch and a parking start switch. The driving assistance ECU 10, as described later, executes automatic parking control when the automatic parking control switch is ON, and, when the parking start switch is turned ON during execution of the automatic parking control, starts control of vehicle movement by autonomous driving.

A drive device 22 that accelerates the vehicle 102 by applying driving force to drive wheels 24 is connected to the drive ECU 20. The drive ECU 20, under normal conditions, controls the drive device 22 so that the driving force generated by the drive device 22 varies according to driving operations by the driver, and, when a command signal is received from the driving assistance ECU 10, controls the drive device 22 based on the command signal. Accordingly, the drive ECU 20 and the drive device 22 cooperate with each other to function as a drive control device 26.

A brake device 32 that decelerates the vehicle 102 by applying braking force to wheels 34 is connected to the brake ECU 30. The brake ECU 30, under normal conditions, controls the brake device 32 so that the braking force generated by the brake device 32 varies according to braking operations by the driver, and, when a command signal is received from the driving assistance ECU 10, performs automatic braking by controlling the brake device 32 based on the command signal. The wheels 34 include the drive wheels 24.

Accordingly, the brake ECU 30 and the brake device 32 cooperate with each other to function as a brake control device 36, which can control the braking force of the entire vehicle 102 as well as individually control the braking force of each wheel. Note that, when braking force is applied to the wheels by parking control or the like, brake lamps (not shown in FIG. 1) are lit.

An EPS Device 42 is connected to the EPS ECU 40. The EPS ECU 40, based on a steering torque and a vehicle speed detected by a driving operation sensor 60 and a vehicle state sensor 70 described later, controls the EPS device 42 in a known manner in the art to control steering assist torque and thereby reduce steering load of the driver. Furthermore, the EPS ECU 40 can also steer steered wheels 44 by controlling the EPS device 42 when necessary. Accordingly, the EPS ECU 40 and the EPS device 42 cooperate with each other to function as a steering control device 46 that automatically steers the steered wheels as needed.

The drive control device 26, the brake control device 36, and the steering control device 46, in cooperation with the driving assistance ECU 10, function as an autonomous driving device 80 that moves the vehicle 102 by autonomous driving. As described in detail later, the driving assistance ECU 10 sets a target trajectory from a parking start position to a target parking position based on information acquired by the object information acquisition device 18. Furthermore, the driving assistance ECU 10 controls the autonomous driving device 80 so that the vehicle moves by the autonomous driving along the target trajectory from the parking start position to the target parking position.

A touch-panel display device 52 for displaying control status of the driving assistance ECU 10 and an alarm device 54 for issuing an alert are connected to the meter ECU 50. The display device 52 may be, for example, a multi-information display that displays meters and various types of information, or a display of a navigation device. Upon receiving a signal from the driving assistance ECU 10, the display device 52 may display the status of the parking assistance control.

The alarm device 54 is activated when it is determined that the vehicle 102 cannot be parked at a target parking position desired by the driver, and notifies that the vehicle cannot be parked. The alarm device 54 may be a device such as an indicator lamp or a device that emits an audible alert such as a buzzer.

The driving operation sensor 60 and the vehicle state sensor 70 are also connected to the CAN 104. Information detected by the driving operation sensor 60 and the vehicle state sensor 70 (referred to as sensor information) is transmitted to the CAN 104. The sensor information transmitted to the CAN 104 is available for appropriate use by each ECU. The sensor information may also be information of a sensor connected to a specific ECU and transmitted to the CAN 104 from the specific ECU.

The driving operation sensor 60 includes a drive operation amount sensor that detects an amount of accelerator pedal operation, a brake operation amount sensor that detects a master cylinder pressure or a pedal force applied to a brake pedal, and a brake switch that detects whether or not the brake pedal is operated. The driving operation sensor 60 further includes a steering angle sensor that detects a steering angle and a steering torque sensor that detects a steering torque.

The vehicle state sensor 70 includes a vehicle speed sensor for detecting a vehicle speed V of the vehicle 102, a longitudinal acceleration sensor for detecting a longitudinal acceleration of the vehicle, a lateral acceleration sensor for detecting a lateral acceleration of the vehicle, and a yaw rate sensor for detecting a yaw rate of the vehicle.

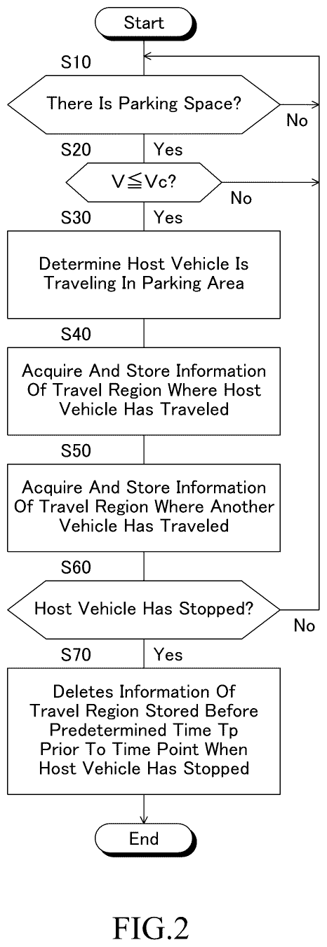

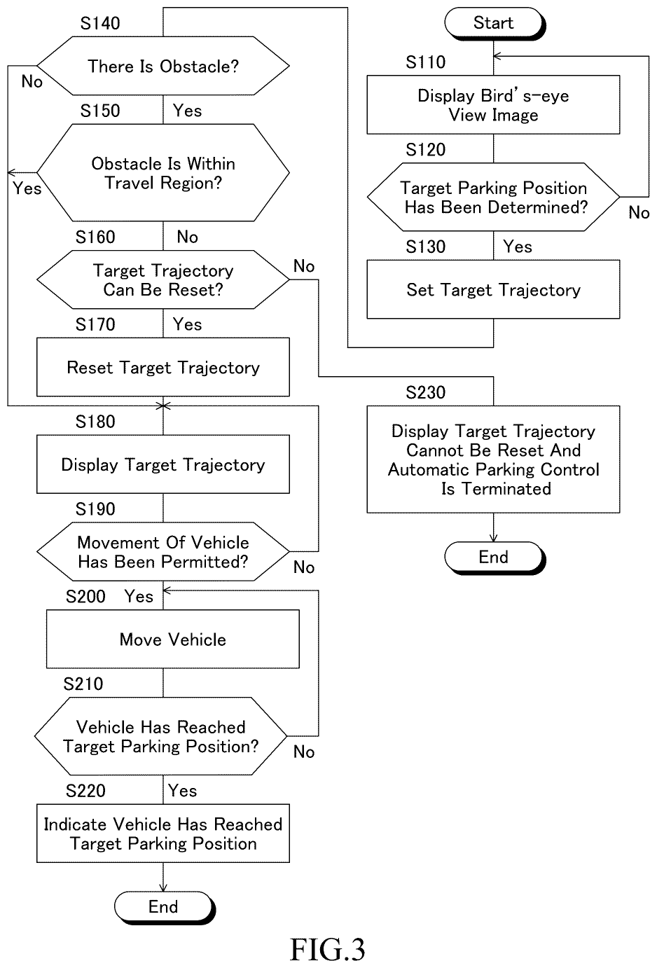

In the embodiment, the ROM of the driving assistance ECU 10 stores a program for travel region information acquisition control corresponding to the flowchart shown in FIG. 2, and a program for automatic parking control corresponding to the flowchart shown in FIG. 3.

### Control Program for Acquiring Information of Travel Region (FIG. 2)

Next, with reference to the flowchart shown in FIG. 2, the control program for acquiring information of a travel region in the embodiment will be described. The control of acquiring information of a travel region by the flowchart of FIG. 2 is executed by the CPU of the driving assistance ECU 10 when an ignition switch (IGSW), not shown in FIG. 1, is ON.

First, in step S10, the CPU determines, based on the information acquired by the object information acquisition device 18, whether or not there is at least one parking space within a search range of a predetermined distance Lc (a positive constant) from the host vehicle 102. When the determination is negative, step S10 is repeatedly executed. When the determination is affirmative, the control proceeds to step S20.

In step S20, the CPU determines whether or not the vehicle speed V is equal to or lower than a reference value Vc (for example, a positive constant of 15 km/h). When the determination is negative, it is considered that the driver does not intend to park, and the control returns to step S10. When the determination is affirmative, the control proceeds to step S30.

In step S30, the CPU determines that the host vehicle 102 is traveling in a parking area. It should be noted that step S20 may be omitted, and in such case, when the determination in step S10 is affirmative, it may be determined that the host vehicle is traveling in a parking area.

In step S40, the CPU acquires information of a travel region where the host vehicle 102 has traveled within the search range, based on the information acquired by the object information acquisition device 18, and stores the information in the RAM.

In step S50, the CPU acquires information of a travel region where another vehicle has traveled within the search range, based on the information acquired by the object information acquisition device 18, and stores the information in the RAM. When there are a plurality of obstacles, information of the travel region is acquired and stored for each obstacle.

In step S60, the CPU determines whether or not the host vehicle 102 has stopped. When the determination is negative, the control returns to step S10. When the determination is affirmative, the control proceeds to step S70.

In step S70, the CPU deletes, from information of the travel region stored in RAM, information of the travel region that was stored before a predetermined time Tp (a positive constant) prior to a time point when the host vehicle 102 has stopped. That is, information of travel regions distant from the current position of the host vehicle is deleted.

It should be noted that, even after the host vehicle has stopped, information of a travel region in which another vehicle has traveled may still be acquired and stored, for example, until the automatic parking control switch is turned ON.

### Automatic Parking Control Program (FIG. 3)

Next, with reference to the flowchart shown in FIG. 3, the automatic parking control program according to the embodiment will be described. The automatic parking control according to the flowchart of FIG. 3 is executed by the CPU of the driving assistance ECU 10 when the automatic parking control switch is ON.

First, in step S110, the CPU causes the display 52 to display a bird's-eye view image of the surroundings of the vehicle 102. It should be noted that, by touching an image selection icon on the display 52, an all-around bird's-eye view image, a left-side bird's-eye view image, a right-side bird's-eye view image, a front bird's-eye view image, and a rear bird's-eye view image may be selectively displayed.

In step S120, the CPU determines whether or not a desired parking position (target parking position) has been determined by the driver by touching a parking-available position (parking space) displayed on the display 52. When the determination is negative, the control returns to step S110. When the determination is affirmative, the control proceeds to step S130. It should be noted that, after determining the desired parking position, the driver may exit the vehicle 102, and thereafter issue necessary instructions for remote parking by operating a terminal device.

In step S130, the CPU sets a target trajectory from the current position of the vehicle 102 to the target parking position in a manner known in the art.

In step S140, the CPU determines, based on the information acquired by the object information acquisition device 18, whether or not there is an obstacle that obstructs the movement of the host vehicle 102 along the target trajectory from the parking start position to the target parking position. When the determination is negative, the control proceeds to step S180. When the determination is affirmative, the control proceeds to step S150.

In step S150, the CPU determines whether or not the obstacle is within a travel region stored in RAM. When the determination is affirmative, the control proceeds to step S180. When the determination is negative, the control proceeds to step S160. When a plurality of obstacles exist, an affirmative determination is made only when all of the obstacles are within the travel region.

In step S160, the CPU determines whether or not the target trajectory can be reset so that the host vehicle does not collide with the obstacle. When the determination is negative, that is, when it is determined that the target trajectory cannot be reset due to the obstacle, the control proceeds to step S230. On the other hand, when the determination is affirmative, that is, when it is determined that the target trajectory can be reset so as not to be obstructed by the obstacle, the control proceeds to step S170.

In step S170, the CPU resets the target trajectory from the parking start position to the target parking position in a manner known in the art, so that the host vehicle does not collide with the obstacle. When a plurality of obstacles exists, the target trajectory is reset so that the host vehicle does not collide with any of the obstacles.

In step S180, the CPU displays the target trajectory on the display 52 and also displays a “Parking Start” icon functioning in the same manner as the parking start switch. It should be noted that a plurality of target trajectories may be displayed for selection.

In step S190, the CPU determines whether or not movement of the vehicle 102 by the autonomous driving has been permitted by operation of the parking start switch or by touching the “Parking Start” icon displayed on the display 52. When the determination is negative, the control returns to step S180. When the determination is affirmative, the control proceeds to step S200. When a plurality of target trajectories are displayed, an affirmative determination is made after one of the target trajectories has been selected by touch and permission of the autonomous driving has been given.

In step S200, the CPU, in cooperation with other ECUs, moves the vehicle 102 to the target parking position along the target trajectory by the autonomous driving that automatically controls the drive device 22, the brake device 32, and the EPS device 42. It should be noted that, in moving the vehicle to the target parking position by the autonomous driving, the EPS device 42 is automatically controlled so that the vehicle moves along the target trajectory, while the drive device 22 and the brake device 32 may alternatively be controlled by the driver.

In step S210, the CPU determines, based on the information acquired by the object information acquisition device 18, whether or not the vehicle 102 has reached the target parking position. When the determination is negative, the control returns to step S200. When the determination is affirmative, the control proceeds to step S220.

In step S220, the CPU causes the display 52 to indicate that the vehicle 102 has reached the target parking position, and terminates the control. In the case of remote parking, the fact that the vehicle 102 has reached the target parking position is displayed on a display of the terminal device. It should be noted that the shift position may be shifted to a P range and the ignition switch may be turned off.

In step S230, the CPU notifies occupants of the vehicle, by displaying on the display 52 that the target trajectory cannot be reset and that the automatic parking control is terminated, and then terminates the control. The alarm device 54 may also be activated.

### Operation of the Embodiment

As will be understood from the above description, the parking assistance control according to the embodiment is executed by performing the control for acquiring travel region information according to the flowchart shown in FIG. 2, together with the automatic parking control according to the flowchart shown in FIG. 3.

In the control for acquiring travel region information (FIG. 2), when it is determined that there is a parking space within the search range around the host vehicle (S10), and when it is determined that the vehicle speed V is equal to or lower than the reference value Vc (S20), it is determined that the host vehicle is traveling in a parking area (S30). Information of a travel region in which the host vehicle 102 has traveled within the search range is acquired and stored in the RAM (S40). Further, when another vehicle has traveled within the search range, information of the travel region in which the other vehicle has traveled is acquired and stored in the RAM (S50).

The automatic parking control (FIG. 3) is started when the automatic parking control switch is turned ON. A bird's-eye view image of the surroundings of the vehicle 102 is displayed on the display 52 (S110). When the driver determines a target parking position by touching a parking-available position displayed on the display (S120), a target trajectory from a current position of the vehicle to the target parking position is set (S130).

After the target trajectory is set, it is determined, based on the information acquired by the object information acquisition device 18, whether or not there is an obstacle that obstructs the movement of the host vehicle 102 along the target trajectory from the parking start position to the target parking position (S140).

When it is determined that an obstacle exists, it is then determined whether or not the obstacle is within the travel region stored in the RAM (S150). When it is determined that the obstacle is not within the travel region, that is, when it is determined that the obstacle obstructs the movement of the host vehicle 102 along the target trajectory, it is determined whether or not the target trajectory can be reset so as to avoid collision of the host vehicle with the obstacle (S160).

When it is determined that the target trajectory cannot be reset, the occupants are notified that the target trajectory cannot be reset (S230). On the other hand, when it is determined that the target trajectory can be reset, the target trajectory is reset so that the host vehicle does not collide with the obstacle (S170), and the target trajectory is displayed on the display 52 (S180).

Further, when it is determined that there is no obstacle (S140), or when it is determined that there is an obstacle but the obstacle is within the travel region (S150), the target trajectory is displayed on the display 52 without being reset (S180).

Further, when it is determined that movement of the host vehicle 102 by the autonomous driving has been permitted (S190), the host vehicle is moved by the autonomous driving to the target parking position (S200). When it is determined that the host vehicle has reached the target parking position (S210), this fact is displayed on the display 52, and the automatic parking control is terminated (S220).

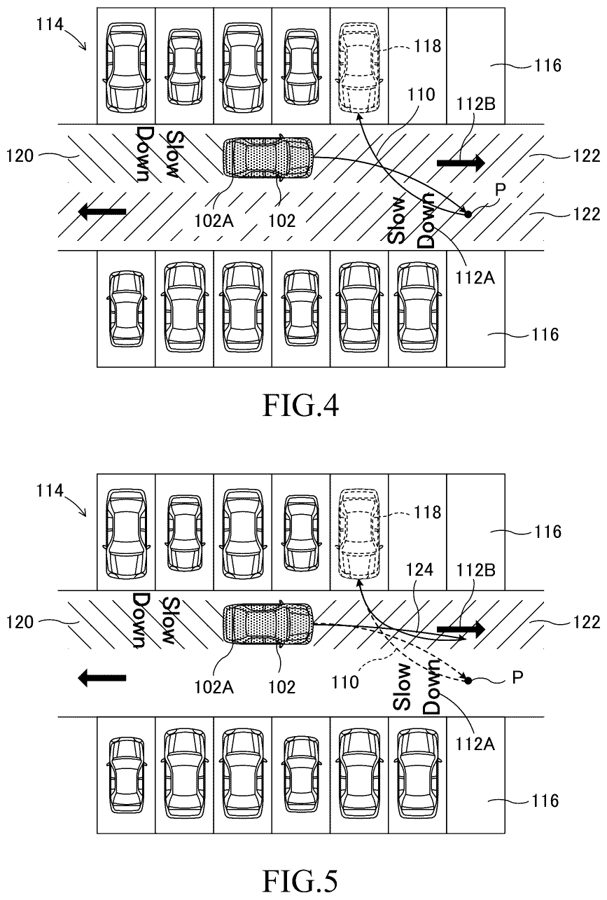

Operations of the embodiment in various cases will be explained referring to FIGS. 4 to 6.

### (1) Case Where an Object Not Constituting an Obstacle is Determined as an Obstacle (FIGS. 4 and 5)

FIGS. 4 and 5 illustrate cases in which road surface markings 112A and 112B are present at or near a position of a target trajectory 110 of the host vehicle 102, and the road surface markings are determined to be obstacles despite the fact that they do not constitute actual obstacles. The road surface markings are not limited to “Slow” and one-way arrows, but may include other markings such as “Stop”.

In FIGS. 4 and 5 and FIG. 6 described later, the host vehicle 102 is shown at the current position, which is a parking start position 102A. Reference numeral 114 denotes a parking area having a plurality of parking spaces 116, reference numeral 118 denotes the target parking position of the host vehicle, reference numeral 120 denotes a travel region in which the host vehicle has traveled, and reference numeral 122 denotes a travel region in which another vehicle has traveled.

In conventional parking assistance devices, when the road surface markings 112A and 112B are determined to be obstacles, it is determined that the target trajectory cannot be reset, and the automatic parking control is terminated. Thus, the host vehicle is not moved to the target parking position by the autonomous driving.

### (1-1) Case Where the Object is Within the Travel Region

In FIG. 4, since the road surface markings 112A and 112B are within the travel region 122, affirmative determinations are made in steps S140 and S150. That is, the road surface markings 112A and 112B are determined not to be obstacles that obstruct the movement of the host vehicle along the target trajectory 110. Accordingly, steps S180 to S220 are executed, so that the automatic parking control is not terminated. As shown in FIG. 4, the host vehicle 102 is moved by the autonomous driving along the target trajectory 110 set in step S130 to the target parking position 118. Reference symbol P denotes a turning point from forward to reverse movement.

### (1-2) Case Where the Object is Not Within the Travel Region

In FIG. 5, the road surface marking 112B is within the travel region 122, but the road surface marking 112A is not within the travel region. In step S140, an affirmative determination is made, but in step S150, a negative determination is made. Accordingly, when it is possible to reset the target trajectory, an affirmative determination is made in step S160, and in step S170 the target trajectory is reset. Further, since steps S180 to S220 are executed, the automatic parking control is not terminated. As shown in FIG. 5, the host vehicle 102 is moved by the autonomous driving along a reset target trajectory 124 set in step S170 to the target parking position 118.

Accordingly, in either of cases (1-1) and (1-2), the host vehicle 102 can be moved by the autonomous driving along the target trajectory to the target parking position 118.

However, in cases (1-2), when the target trajectory cannot be reset, a negative determination is made in step S160, and in step S230, the occupants are notified that the target trajectory cannot be reset and that the automatic parking control is terminated.

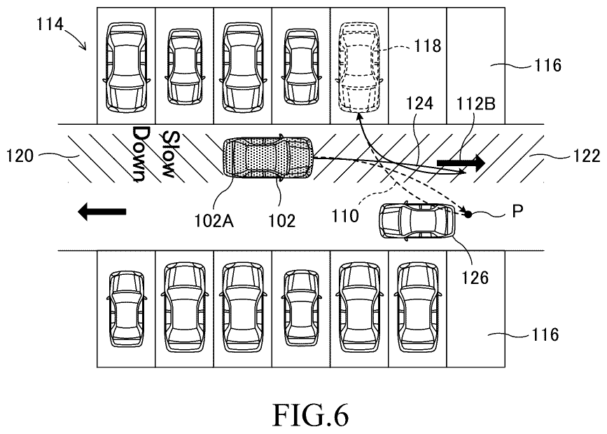

### (2) Case Where an Object Constituting an Obstacle is Determined as an Obstacle (FIG. 6)

FIG. 6 illustrates a case in which an object 126 that constitutes an obstacle that obstructs the movement of the host vehicle 102 is present at or near the position of the target trajectory 110 of the host vehicle, and the object is determined to be an obstacle. The object constituting the obstacle is a stopped vehicle, but may be any object that constitutes an obstacle that obstructs the movement of the host vehicle along the target trajectory.

In this case, an affirmative determination is made in step S140, and a negative determination is made in step S150. Accordingly, the automatic parking control is executed in the same manner as in case (1-2).

### (3) Case Where No Obstacle is Determined

Although not illustrated, when there is no object constituting an obstacle that obstructs the movement of the host vehicle 102 at or near a position of the target trajectory, a negative determination is made in step S140. Accordingly, steps S180 to S220 are executed, so that, as in case (1), the host vehicle is moved by the autonomous driving along the target trajectory set in step S130 to the target parking position 118.

As will be understood from the above description, according to the embodiment, when the host vehicle 102 is traveling in a parking area 114 (S10), information of a travel region in which at least one of the host vehicle and another vehicle has traveled is stored based on the information acquired by the object information acquisition device 18 (S40, S50). Further, even when it is determined that there is an obstacle that obstructs the movement of the host vehicle along the target trajectory 110 from the parking start position 102A to the target parking position 118 (S140), when it is determined that the obstacle is within the travel region (S150), the host vehicle is automatically moved along the target trajectory (S180-S220).

Accordingly, it is possible to prevent the parking assistance control from being unnecessarily terminated, and to prevent the target trajectory from being reset to a non-optimal trajectory that avoids a region in which the vehicle can in fact travel.

Moreover, no device for detecting obstacles other than the object information acquisition device 18 is required. Thus, it is possible to avoid complicating the structure of the parking assistance device and to avoid increasing the cost thereof.

Further, according to the embodiment, it is determined whether or not the obstacle is within the travel region based on the information of the travel region stored after a time point that is a predetermined time Tp before a time point when the host vehicle has stopped (S10-S70, S150).

Accordingly, it is possible to prevent determination of whether or not the obstacle is within the travel region from being made based on old information of the travel region in which at least one of the host vehicle and another vehicle has traveled. Furthermore, the storage capacity required for the storage device for storing the travel region can be reduced.

Furthermore, according to the embodiment, when it is determined, based on the information acquired by the object information acquisition device 18, that at least one parking space 116 is within a predetermined distance Le from the host vehicle 102 (S10), and when it is determined that the vehicle speed V of the host vehicle is equal to or lower than the reference value Vc (S20), it is determined that the host vehicle is traveling in a parking area (S30).

Accordingly, when the host vehicle is traveling in an area where parking is possible, it can be determined that the host vehicle is traveling in a parking area, and when the host vehicle is traveling in an area where parking is not possible, it is possible to prevent unnecessary storage of travel region information. Furthermore, even when the host vehicle is traveling in a parking area but merely passes through the parking area without parking, it is possible to prevent unnecessary determination that the host vehicle is traveling in a parking area and unnecessary acquisition and storage of travel region information.

Furthermore, according to the embodiment, when it is determined that the obstacle is not within the travel region (S150), the target trajectory 124 is reset so that the host vehicle 102 does not collide with the obstacle (S170). Accordingly, it is possible to prevent the parking assistance control from being terminated, and the host vehicle can be moved to the target parking position and parked without colliding with the obstacle.

Although the present disclosure has been described in detail with respect to specific an embodiment, the disclosure is not limited to the above-described embodiment, and it will be apparent to those skilled in the art that various other embodiments are possible within the scope of the present disclosure.

For example, in the above-described embodiment, in step S10, it is determined whether or not there is at least one parking space within the search range around the host vehicle 102. However, instead of or in addition to step S10, it may be determined whether or not the host vehicle is traveling in a parking area based on information from a navigation device.

Further, in the above-described embodiment, when it is determined in step S150 that the obstacle is not within the travel region stored in the RAM, the control proceeds to step S160. However, alternatively, when it is determined in step S150 that the obstacle is not within the travel region stored in the RAM, the automatic parking control may be terminated without executing steps S160 and S170.

Furthermore, in the above-described embodiment, in step S110, a bird's-eye view image of the surroundings of the vehicle 102 is displayed on the display 52, and when it is determined in step S120 that the target parking position has been determined, a target trajectory from the current position of the vehicle 102 to the target parking position is set in step S130. However, the target trajectory may be set in any known manner in the art.

What is claimed is:

1. A parking assistance device comprising:
an object information acquisition device configured to acquire information of objects around a host vehicle; and
an electronic control unit that is configured to set a target trajectory from a parking start position to a target parking position based on information acquired by the object information acquisition device, and to execute automatic parking control for controlling the host vehicle to automatically move along the target trajectory from the parking start position to the target parking position,
wherein the electronic control unit is configured, when the host vehicle is traveling in a parking area, to store information of a travel region in which at least one of the host vehicle and another vehicle has traveled based on the information acquired by the object information acquisition device, and, even if the electronic control unit determines that there is an obstacle that obstructs the movement of the host vehicle along the target trajectory from the parking start position to the target parking position, to automatically move the host vehicle along the target trajectory when the electronic control unit further determines that the obstacle is within the travel region.

2. The parking assistance device according to claim 1, wherein the electronic control unit is configured to determine whether or not the obstacle is within the travel region based on the information of the travel region stored after a time point that is a predetermined time before a time point when the host vehicle has stopped.

3. The parking assistance device according to claim 1, wherein the electronic control unit is configured to determine that the host vehicle is traveling in a parking area when the electronic control unit determines, based on the information acquired by the object information acquisition device, that at least one parking space is within a predetermined distance from the host vehicle.

4. The parking assistance device according to claim 3, wherein the electronic control unit is configured to determine that the host vehicle is traveling in a parking area when the electronic control unit determines, based on the information acquired by the object information acquisition device, that at least one parking space is within the predetermined distance from the host vehicle and that a vehicle speed of the host vehicle is equal to or lower than a reference value.

5. The parking assistance device according to claim 1, wherein the electronic control unit is configured, when the electronic control unit determines that the obstacle is not within the travel region, to reset the target trajectory so that the host vehicle does not collide with the obstacle.
